(19) United States
(12) Patent Application Publication
(10) Pub. No.: US 2017/0167891 A1
(43) Pub. Date: Jun. 15, 2017

(54) POSITION DETECTING APPARATUS

(71) Applicant: Seiko Epson Corporation, Tokyo (JP)

(72) Inventors: Akitoshi MAEDA, Shiojiri (JP); Atsuto KITAHARA, Shimosuwa (JP)

(21) Appl. No.: 15/372,757

(22) Filed: Dec. 8, 2016

(30) Foreign Application Priority Data
Dec. 10, 2015 (JP) 2015-241616
Dec. 10, 2015 (JP) 2015-241617

(51) Int. Cl. G01D 5/14; F16H 1/22

(52) U.S. Cl. CPC G01D 5/14; F16H 1/22

(57) ABSTRACT

A position detecting apparatus includes: a main gear on a main shaft rotatable around a shaft center, and rotating with the main shaft; two or more auxiliary gears connected to the main gear, configured with a different number of teeth than the main gear, and configured to have a different number of teeth than each other; magnetic angle sensors respectively provided on the auxiliary gears, and configured to detect rotating angles of the auxiliary gears; a first polarization plate provided on the main shaft, and rotating with the main shaft; counter polarization plates provided at positions facing the first polarization plate, and having polarization angles deviated from each other by 45°; a light source irradiating the first polarization plate and the counter polarization plates; and light receptors detecting light irradiated from the light source and passing through the first polarization plate and the counter polarization plates.

### BACKGROUND

1. Technical Field

The present invention relates to a position detecting apparatus.

2. Related Art

In industrial equipment which produces and measures products, it is necessary to accurately drive driving parts, such as arms. Here, in a case in which rotation of the driving parts are driven, it is possible to improve accuracy of rotation driving of the driving parts by detecting positions of the driving parts, that is, by accurately detecting rotating angles.

In a case in which the rotating angles of the driving parts (for example, a rotating angle of a main shaft of a motor) are detected, a rotary encoder is generally used (for example, refer to JP-A-60-239608).

The rotary encoder disclosed in JP-A-60-239608 is a magnetic-type absolute rotary encoder. The rotary encoder includes a first gear that is provided on a main shaft, a second gear that is engaged with the first gear, and a third gear that is engaged with the first gear. The numbers of teeth of the respective gears are coprime to each other, and magnetic-type rotating angle sensors (resolvers) are provided in the respective gears. In the rotary encoder, a rotating angle of the main shaft is calculated by detecting engagement states of the gears based on rotating angles of the respective gears which are detected by the resolvers.

However, the magnetic-type rotary encoder disclosed in JP-A-60-239608 is influenced by magnetic hysteresis and temperature drift, and thus measurement accuracy is limited.

In contrast, there is an optical-type absolute encoder as the rotary encoder. In the optical-type rotary encoder, the rotating angle is detected by forming an optical disk, in which an absolute pattern of an absolute value detection quantity is formed, on the main shaft, irradiating the optical disk with light from a light source unit, and detecting reflected light or transmitted light thereof. In the optical-type absolute rotary encoder, highly-accurate angle detection is possible. However, it is necessary to form a complex absolute pattern on the optical disk, with the result that initial costs are necessary, thereby causing a problem of high price.

### SUMMARY

An advantage of some aspects of the invention is to solve at least a part of the problems described above, and the invention can be implemented as the following aspects or application examples.

A position detecting apparatus according to an application example of the invention includes: a main gear that is provided on a main shaft which is capable of rotating around a shaft center, and that is rotated together with the main shaft; two or more auxiliary gears that are connected to the main gear, configured to have the numbers of teeth which are different from the number of teeth of the main gear, and configured to have the numbers of teeth which are different from each other; magnetic angle sensors that are respectively provided in the two or more auxiliary gears, and are configured to detect rotating angles of the respective auxiliary gears; a polarization plate that is provided on the main shaft, and is rotated together with the main shaft; two or more counter polarization plates that are provided in different positions within an area which faces the polarization plate, and are configured to have polarization directions which are deviated from each other by an interval of 45°; a light source unit that irradiates the polarization plate and the counter polarization plates with light; and a light detection unit that detects light which is irradiated from the light source unit and passes through the polarization plate and the counter polarization plates.

Here, in the invention, the case, in which the two or more auxiliary gears are connected to the main gear, includes a configuration in which another gear is engaged with the main gear and the auxiliary gears are engaged with the another gear in addition to a configuration in which the two or more auxiliary gears are directly engaged with the main gear. In addition, a configuration, in which one (first auxiliary gear) of the two or more auxiliary gears is engaged with the main gear and the other auxiliary gear is engaged with the first auxiliary gear, may be further included.

According to the application example, the position detecting apparatus is a position detecting apparatus which detects an absolute rotating angle of the main shaft. In the position detecting apparatus, a first encoder includes the main gear that is provided on the main shaft, the plurality of auxiliary gears that are engaged with the main gear, and the magnetic angle sensors that detect rotating angles of the respective auxiliary gears. In addition, an optical-type second encoder includes the polarization plate that is provided on the main shaft, the plurality of counter polarization plates that face the polarization plate, the light source unit, and the light detection unit.

According to the application example, in the position detecting apparatus, it is possible to detect the number of times, in which the main shaft performs half-rotation, by the first encoder. In contrast, if a magnetic-type sensor is used as a rotation number detection unit, the first encoder is influenced by, for example, magnetic hysteresis and temperature drift, and thus it is difficult to accurately detect the rotating angles.

In contrast, according to the application example, the second encoder is further provided. The second encoder emits light from the light source unit such that light passes through the polarization plate and the counter polarization plates, and detects light which is transmitted through the polarization plate and the counter polarization plates using the light detection unit. In addition, two or more counter polarization plates are provided, polarization angles are deviated (inclined) by 45° from each other, and light which passes through the respective counter polarization plates is detected by the light detection unit. In the second encoder, a phase of light, which passes through one counter polarization plate, and a phase of light, which passes through the other counter polarization plate, are deviated by 45°, and thus it is possible to accurately detect a relative rotating angle of the main shaft against an initial position based on combination of light quantities of the respective light.

However, although it is possible for the second encoder to detect the relative rotating angle of the main shaft against the initial position, it is difficult for the second encoder to detect the absolute rotating angle. In contrast, according to the application example, since it is possible to acquire the number of absolute rotation of the main shaft using the first encoder, it is possible to highly accurately detect the absolute rotating angle, from which the influence of magnetic hysteresis and temperature drift is excluded, by adding detection results of the first encoder and the second encoder.

In addition, the magnetic angle sensors, which are cheap and have a simple configuration, are used as the first encoder, and cheap polarization plates are used as the second encoder without using an optical disk or the like on which an absolute pattern is formed. Therefore, it is possible to reduce the cost of the position detecting apparatus.

In the position detecting apparatus according to the application example, it is preferable that the number of teeth of the main gear is an even number, and ½ of the number of teeth of the main gear and the respective numbers of teeth of the two or more auxiliary gears are coprime to each other.

In the magnetic-type absolute encoder according to the related art as disclosed, for example, in JP-A-60-239608, the number of times in which one rotation is repeated in the respective gears is detected, and the numbers of teeth of the respective gears are coprime to each other. In contrast, the second encoder detects the relative rotating angle within the half-rotation of the main shaft. Accordingly, even though the magnetic-type absolute encoder according to the related art is combined with the second encoder, it is difficult to highly accurately detect the absolute rotating angle.

In contrast, according to the application example, the number of teeth of the main gear in the first encoder is an even number (2a), and the numbers of teeth (b and c) of the two or more auxiliary gears are different from the number of teeth of the main gear (b≠2a and c≠2a), and, a, b, and c are coprime to each other. In the configuration, it is possible to detect the number of rotations in a unit of half-rotation of the main shaft. Accordingly, if the number of rotations in a unit of half-rotation of the main shaft, which is detected by the first encoder, is added to a relative rotating angle within the half-rotation detected by the second encoder, it is possible to highly accurately detect the absolute rotating angle.

A position detecting apparatus according to an application example of the invention includes an angle detection sensor that detects the rotating angle of the main shaft which is capable of being rotated around the shaft center; and an optical-type encoder that detects the rotating angle of the main shaft. The optical-type encoder is provided on a rotation body that is rotated together with the main shaft, and includes a plurality of first slits that are arranged along a first virtual circle around the shaft center, and a first detection unit that detects light which passes through the first slits. A distance between ends on one side of two adjacent first slits along the first virtual circle is equal to or longer than 4/3 of a prescribed error which is prescribed by the angle detection sensor.

According to the application example, the position detecting apparatus includes the angle detection sensor and the optical encoder. Here, it is possible to use, for example, a magnetic angle sensor or the like as the angle detection sensor, and the magnetic angle sensor is available at a low cost with a simple configuration. However, since the magnetic angle sensor is influenced by magnetic hysteresis and temperature drift, a detection error is generated. It is possible to measure the detection error, which may be generated in the angle detection sensor, as the prescribed error in advance. Furthermore, according to the application example, the optical-type encoder includes the plurality of first slits that are provided in the rotation body which is rotated together with the main shaft, and the first detection unit that detects light which is transmitted through the first slits. In the plurality of first slits, an interval between the adjacent first slits (the distance between ends on one side along the first virtual circle and a light and dark width of a light and dark pattern which is formed by the first slits) is equal to or larger than 4/3 of the prescribed error. That is, the prescribed error is equal to or smaller than ¾ of the interval between the adjacent first slits.

In the configuration, even in a case in which an error is generated within a prescribed error range when an angle is detected in the angle sensor, it is possible to perform highly accurate measurement, from which the influence of the error is reduced, in such a way that light (diffracted light) which passes through the first slits of the optical-type encoder is received by the first detection unit.

That is, in a case in which the interval between the adjacent first slits is smaller than 4/3 of the prescribed error of the angle sensor, a prescribed error range against the cycle of diffracted light, which is diffracted through the first slits, becomes large. Here, there is a case in which the prescribed error is included in a detection value which is detected by the angle sensor and a plurality of rotating angles corresponding to a detection signal from the first detection unit are included in the prescribed error. In this case, it is difficult to determine which rotating angle corresponds to the detection signal from the first detection unit. In contrast, with the configuration, only one rotating angle of the main shaft corresponding to the detection signal from the first detection unit is determined within the measurement error range, with the result that the above-described problem is not generated, and thus it is possible to highly-accurately detect the rotating angle of the main shaft.

In the position detecting apparatus according to the application example, it is preferable that the optical-type encoder further includes a plurality of second slits that are provided on the rotation body, are arranged along a second virtual circle around the shaft center, and are arranged at an interval which is smaller than an arrangement interval between the plurality of first slits; and a second detection unit that detects light which passes through the second slits.

According to the application example, the second slits that have a slit interval, which is smaller than an arrangement interval (slit interval) between the first slits, and the second detection unit that detects light (diffracted light) which passes through the second slits are further provided. In the optical-type encoder that detects diffracted light which passes through the slits, it is possible to improve resolution by reducing the slit interval. However, as described above, the first slits are configured to be arranged at an interval which is equal to or larger than 4/3 of the prescribed error of the angle sensor. Therefore, the slit interval is relatively large, and thus the optical-type encoder is unsuitable for high-resolution measurement. In contrast, according to the application example, it is possible to perform high-resolution measurement using the second slits and the second detection unit by providing the second slits whose slit interval is smaller than that of the first silts, and the second detection unit as described above. That is, according to the application example, it is possible to highly-accurately measure the absolute position using the angle detection sensor, the first slits, and the first detection unit, and it is possible to perform high-resolution measurement using the second slits and the second detection unit.

In the position detecting apparatus according to the application example, it is preferable that the second slits are arranged in positions which are far from the main shaft rather than the first slits.

According to the application example, the second slits whose slit interval is smaller than that of the first slits are provided on a side (outer circumferential side) which is separated from the main shaft rather than the first slits. In other words, a diameter dimension of the second virtual circle in which the second slits are arranged is larger than a diameter dimension of the first virtual circle in which the first slits are arranged. With the configuration, it is possible to provide the plurality of second slits whose slit interval is narrow along the second virtual circle which has a large circumference, and thus it is possible to detect the rotating angle of the main shaft with higher resolution.

### BRIEF DESCRIPTION OF THE DRAWINGS

The invention will be described with reference to the accompanying drawings, wherein like numbers reference like elements.

FIG. 1 is a plan view illustrating a schematic configuration of a position detecting apparatus according to a first embodiment of the invention.

FIG. 2 is a side view illustrating the schematic configuration of the position detecting apparatus according to the first embodiment.

FIG. 3 is a flowchart illustrating a position detecting method using the position detecting apparatus according to the first embodiment.

FIG. 4 is a graph illustrating an example of second data according to the first embodiment.

FIG. 5 is a graph illustrating an example of the second data according to a modification example of the invention.

FIG. 6 is a plan view illustrating a schematic configuration of a position detecting apparatus according to a second embodiment of the invention.

FIG. 7 is a sectional diagram illustrating the schematic configuration of the position detecting apparatus according to the second embodiment.

FIG. 8 is a graph illustrating a slit interval between first slits and a slit interval between second slits according to the second embodiment.

FIG. 9 is a graph illustrating an example of a prescribed error of a magnetic angle sensor and a detection signal of an optical-type encoder in a rotary encoder according to the related art.

### DESCRIPTION OF EXEMPLARY EMBODIMENTS

### First Embodiment

Hereinafter, an embodiment of the invention will be described.

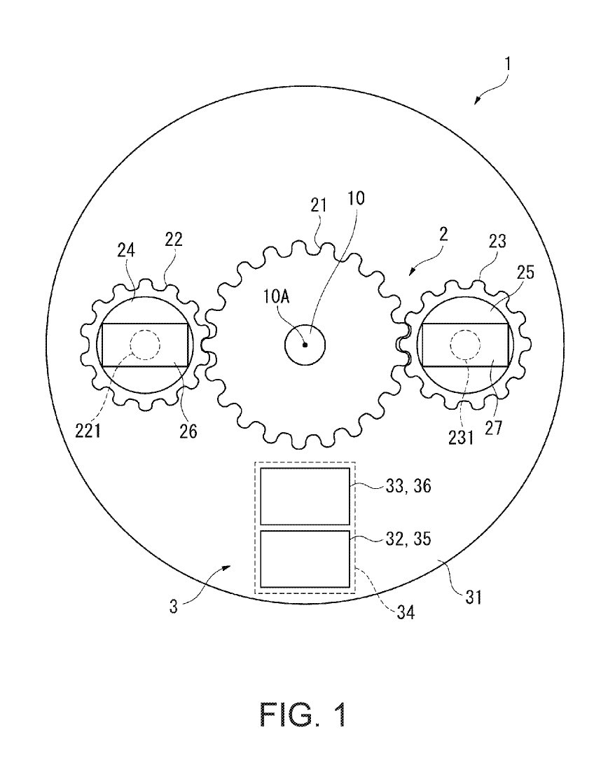

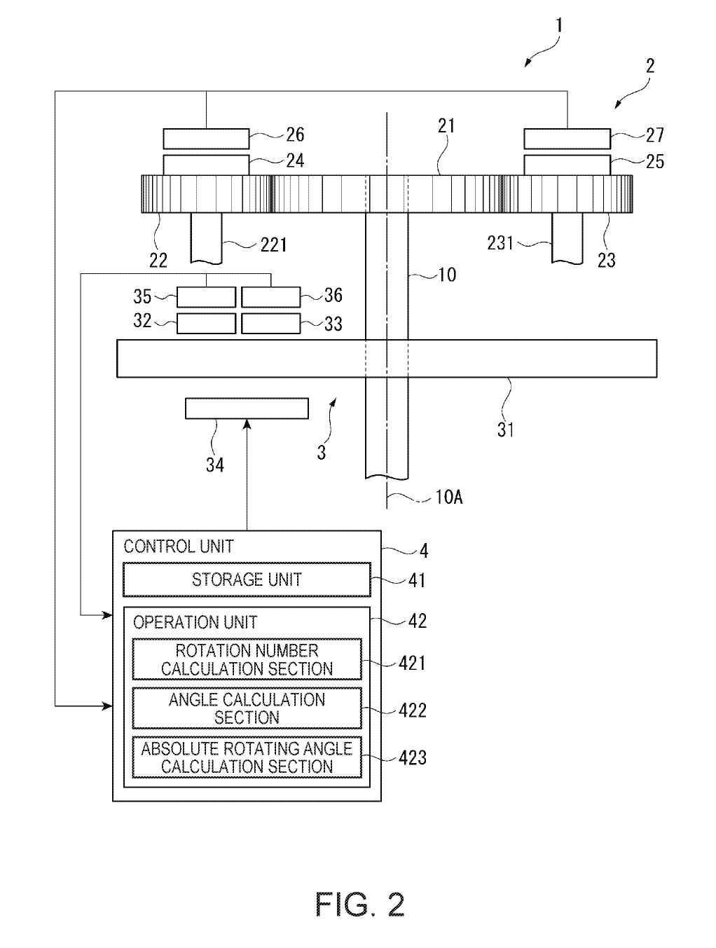

FIG. 1 is a plan view illustrating a schematic configuration of a position detecting apparatus 1 according to the embodiment of the invention, and FIG. 2 is a side view illustrating the schematic configuration of the position detecting apparatus 1 according to the embodiment.

In FIG. 1, the position detecting apparatus 1 is an absolute rotary encoder that detects an absolute rotating angle (a rotating angle from an initial position) of a main shaft 10. The position detecting apparatus 1 is attached to a rotation mechanism in an industrial machine (for example, SCARA robot) or the like, and detects a position of the rotation mechanism. For example, in a case in which a position of a drive arm of the industrial machine is detected, a drive shaft of the drive arm is used as a main shaft 10, and the position detecting apparatus 1 according to the embodiment is attached to the drive shaft. In this case, it is possible to detect the position (for example, an arm angle or the like) of the drive arm by detecting an absolute rotating angle of the drive shaft.

Furthermore, the position detecting apparatus 1 includes a first encoder 2, a second encoder 3, a control unit 4 (refer to FIG. 2), as illustrated in FIGS. 1 and 2.

### Configuration of First Encoder

The first encoder 2 includes a main gear 21, a first auxiliary gear 22, a second auxiliary gear 23, a first magnet 24 which is provided on the first auxiliary gear 22, a second magnet 25 which is provided on the second auxiliary gear 23, a first magnetic angle sensor 26 which is provided to face the first auxiliary gear 22, and a second magnetic angle sensor 27 which is provided to face the second auxiliary gear 23.

The main gear 21 is fixed to, for example, one end of the main shaft 10, and is capable of rotating around a shaft center 10A of the main shaft 10, together with the main shaft 10. Meanwhile, in FIGS. 1 and 2, an example in which the main gear 21 is fixed to one end of the main shaft 10. However, the invention is not limited thereto. For example, the main gear 21 may be fixed to an intermediate position of the main shaft 10.

The first auxiliary gear 22 is provided to be capable of being rotated around a shaft 221 which is parallel to the main shaft 10, is engaged with the main gear 21, and is rotated according to the rotation of the main gear 21.

The second auxiliary gear 23 is also provided to be capable of being rotated around a shaft 231 which is parallel to the main shaft 10, is engaged with the main gear 21, and is rotated according to the rotation of the main gear 21, similarly to the first auxiliary gear 22.

Here, the number of teeth of the main gear 21 is an even number (2a). In addition, the number of teeth b of the first auxiliary gear 22 and the number of teeth c of the second auxiliary gear 23 are numbers which are different from each other, and are the numbers which are different from the number of teeth of the main gear 21 (b≠2a, c≠2a, and b≠c). In addition, ½ of the number of teeth 2a of the main gear 21, the number of teeth b of the first auxiliary gear 22, and the number of teeth c of the second auxiliary gear 23 are coprime to each other (a, b, and c are coprime integers).

Meanwhile, in FIGS. 1 and 2, an arrangement in which the first auxiliary gear 22 and the second auxiliary gear 23 are aligned on a straight line is illustrated as an example. However, the invention is not limited thereto. For example, in a plan view, a straight line, which connects centers of the first auxiliary gear 22 and the main shaft 10, and a straight line, which connects centers of the main shaft 10 and the second auxiliary gear 23, may cross by an angle other than 180°.

The first magnet 24 is a radial direction magnet which is provided on the first auxiliary gear 22, and has magnetic poles which are different from each other on one side and the other side along the radial direction. In the same manner, the second magnet 25 is a radial direction magnet which is provided on the second auxiliary gear 23, and has magnetic poles which are different from each other on one side and the other side along the radial direction.

The first magnetic angle sensor 26 is a 360°-angle detection sensor which faces the first magnet 24, and detects a rotating angle of the first auxiliary gear 22 based on directions of the magnetic force lines of the first magnet 24. The second magnetic angle sensor 27 is a 360°-angle detection sensor which faces the second magnet 25, and detects a rotating angle of the second auxiliary gear 23 based on directions of the magnetic force lines of the second magnet 25.

### Configuration of Second Encoder

Subsequently, the second encoder 3 will be described.

The second encoder 3 includes a first polarization plate 31 which is fixed to the main shaft 10, a second polarization plate 32 (corresponding to a counter polarization plate according to the invention) which is provided to face the first polarization plate 31, a third polarization plate 33 (corresponding to a counter polarization plate according to the invention), a light source unit 34, a first light-reception unit 35 (corresponding to a light detection unit according to the invention), and a second light-reception unit 36 (corresponding to a light detection unit according to the invention). Meanwhile, in consideration of viewability of drawings, in FIG. 2, arrangement directions and the arrangement positions of the second polarization plate 32, the third polarization plate 33, the light source unit 34, the first light-reception unit 35, and the second light-reception unit 36 of the second encoder 3 for alignment directions of the main gear 21, the first auxiliary gear 22, and the second auxiliary gear 23 of the first encoder 2 are different from those in FIG. 1. The arrangement positions in the second encoder 3 for the first encoder 2 are not limited to the shapes in FIGS. 1 and 2. For example, in a plan view as illustrated in FIG. 1, the second polarization plate 32, the third polarization plate 33, the light source unit 34, the first light-reception unit 35, and the second light-reception unit 36 may be arranged in positions which overlap the first auxiliary gear 22.

The first polarization plate 31 is a polarization plate which has a plan shape perpendicular to the shaft center 10A of the main shaft 10, and converts incident light into linearly polarized light. The first polarization plate 31 is rotated around the shaft center 10A, together with the main shaft 10, according to the rotation of the main shaft 10.

The second polarization plate 32 is a polarization plate which converts incident light into linearly polarized light, and is provided within an area that overlaps the first polarization plate 31 in a plan view from the shaft direction of the shaft center 10A, as illustrated in FIG. 1.

The third polarization plate 33 is a polarization plate which converts incident light into linearly polarized light, and is provided in a position that is different from the second polarization plate 32 within the area that overlaps the first polarization plate 31 in a plan view, as illustrated in FIG. 1.

Here, the polarization direction of the second polarization plate 32 and a polarization direction of the third polarization plate 33 are deviated by an interval of 45°. That is, the polarization direction of the third polarization plate 33 is included to the polarization direction of the second polarization plate 32 by only 45°.

Meanwhile, the arrangement positions of the second polarization plate 32 and the third polarization plate 33 may be any of positions which are included in the area that overlaps the first polarization plate 31 in a plan view as illustrated in FIG. 1.

The light source unit 34 is provided to face, for example, a surface on a side opposite to a surface which faces the second polarization plate 32 and the third polarization plate 33 of the first polarization plate 31. The light source unit 34 is provided in a position which overlaps the second polarization plate 32 and the third polarization plate 33, and irradiates the first polarization plate 31 with light in a plan view, as illustrated in FIG. 1.

Meanwhile, in FIGS. 1 and 2, an example in which one light source unit 34 is provided is exemplified. However, a configuration may be provided in which light source units are respectively provided in a position which overlaps the second polarization plate 32 and a position which overlaps the third polarization plate 33 in a plan view.

The first light-reception unit 35 is arranged in a position which overlaps the second polarization plate 32 as illustrated in FIG. 1, and is arranged on a side opposite to a side of the first polarization plate 31 of the second polarization plate 32 as illustrated in FIG. 2, in a plan view. The first light-reception unit 35 detects light which is transmitted from the light source unit 34 through the first polarization plate 31 and the second polarization plate 32.

Similarly, the second light-reception unit 36 is arranged in a position which overlaps the third polarization plate 33 in a plan view, and is arranged on a side opposite to a side of the first polarization plate 31 of the third polarization plate 33. The second light-reception unit 36 detects light which is transmitted from the light source unit 34 through the first polarization plate 31 and the third polarization plate 33.

Meanwhile, in the embodiment, a configuration, in which light from the light source unit 34 is transmitted in order of the first polarization plate 31 and the second polarization plate 32 (third polarization plate 33) and is received by the first light-reception unit 35 (second light-reception unit 36), is exemplified. However, the positions of the light source unit 34, the first light-reception unit 35, and the second light-reception unit 36 may be reversed.

In addition, a configuration, in which light transmitted through the first polarization plate 31 and the second polarization plate 32 (third polarization plate 33) is received by the first light-reception unit 35 (second light-reception unit 36), is exemplified. However, the first light-reception unit 35 (second light-reception unit 36) may be capable of receiving light which passes through the first polarization plate 31 and the second polarization plate 32 (third polarization plate 33). Accordingly, for example, a configuration in which light that is transmitted through the first polarization plate 31 and is reflected in the second polarization plate 32 (third polarization plate 33) is received may be provided.

### Configuration of Control Unit

The control unit 4 is connected to each of the magnetic angle sensors 26 and 27 of the first encoder 2 and each of the light-reception units 35 and 36 of the second encoder 3, and calculates an absolute rotating angle of the main shaft 10 based on detection signals which are output from the first encoder 2 and the second encoder 3.

In addition, the control unit 4 may be connected to the light source unit 34, and may control ON and OFF of light performed by the light source unit 34.

The control unit 4 includes a storage unit 41 and an operation unit 42, as illustrated in FIG. 2.

The storage unit 41 includes, for example, a storage circuit such as a memory, and stores various data used to calculate the absolute rotating angle. Meanwhile, the storage unit 41 may store various programs which are executed by the operation unit 42. The various data, which are stored in the storage unit 41, may include, for example, first data used to calculate the number of absolute rotations of the main shaft 10 based on the detection signal from the first encoder 2, second data used to calculate a rotating angle of the main shaft 10 based on the detection signal from the second encoder 3, or the like.

The first data is data which indicates a relationship between the rotating angles of the respective auxiliary gears 22 and 23, which are detected by the respective magnetic angle sensors 26 and 27, and the number of rotations of the main shaft 10.

The second data is data which indicates a relationship between the detection signals from the respective light-reception units 35 and 36 and the rotating angle of the main shaft 10.

Meanwhile, the first data and the second data will be described in detail later.

The operation unit 42 includes, for example, an operation circuit and the like, and calculates the absolute rotating angle of the main shaft 10 based on signals which are input from the first encoder 2 and the second encoder 3. Specifically, the operation unit 42 includes a rotation number calculation section 421, an angle calculation section 422, and an absolute rotating angle calculation section 423. Meanwhile, the operation unit 42 may include a circuit (hardware), such as an IC chip, which functions as the respective sections 421, 422, and 423, and may include a central operation circuit to cause the central operation circuit to function as the respective sections 421, 422, and 423 by reading and executing the various programs (software) from the storage unit 41.

The rotation number calculation section 421 calculates the number of times in which the main shaft 10 performs half-rotation (the number of absolute half-rotations) from the initial position based on the detection signals from the first magnetic angle sensor 26 and the second magnetic angle sensor 27 of the first encoder 2.

The angle calculation section 422 calculates an angle at which the main shaft 10 is rotated from the initial position or a half-rotated position (relative rotating angle) in a range of 0° to 180°.

The absolute rotating angle calculation section 423 calculates the absolute rotating angle of the main shaft 10 based on the number of absolute half-rotations which is calculated by the rotation number calculation section 421 and the relative rotating angle which is calculated by the angle calculation section 422.

Meanwhile, the operations of the respective sections 421, 422, and 423 will be described in detail later.

### Position Detection Method Using Position Detecting Apparatus (Method of Detecting Rotating Angle of Main Shaft)

Subsequently, a position detection method using the position detecting apparatus 1, that is, a method of detecting the rotating angle of the main shaft 10 will be described.

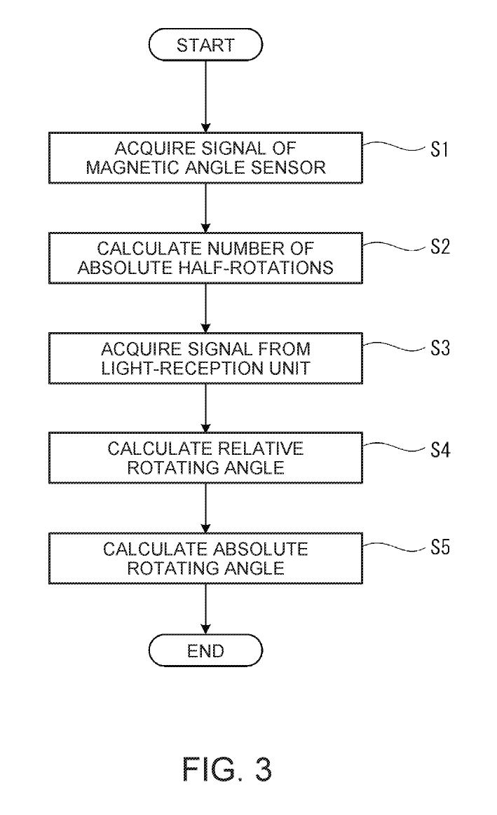

FIG. 3 is a flowchart illustrating the position detecting method using the position detecting apparatus 1 according to the embodiment.

In the position detecting apparatus 1 according to the embodiment, the number of half-rotations (the number of absolute half-rotations) of the main shaft 10 from the initial position (reference position) is acquired based on the detection signal from the first encoder 2 (step S1 and step S2: a process of calculating the number of absolute half-rotations). In addition, the angle at which the main shaft 10 is rotated against the initial position in a range of 0° to 180° is acquired based on the detection signal from the second encoder 3 (step S3 and step S4: a process of calculating the relative rotating angle). Thereafter, in step S5, the absolute rotating angle is calculated based on the calculated number of absolute half-rotations and the relative rotating angle (a process of calculating the absolute rotating angle). Meanwhile, in the embodiment, the process of calculating the relative rotating angle is performed after the process of calculating the number of absolute half-rotations is performed. However, the process of calculating the number of absolute half-rotations may be performed after the process of calculating the relative rotating angle is performed.

Hereinafter, the respective processes will be described in detail.

### Process of Calculating Number of Absolute Half-Rotations

In the process of calculating the number of absolute half-rotations, the rotation number calculation section 421 first acquires the detection signals which are output from the first magnetic angle sensor 26 and the second magnetic angle sensor 27 as shown in step S1. Thereafter, the rotation number calculation section 421 calculates (acquires) the number of absolute half-rotations of the main shaft 10 based on the acquired detection signals and the first data which is stored in the storage unit 41 in step S2.

There is a case in which the magnetic angle sensors 26 and 27 have detection accuracy which is degraded due to the influence of magnetic hysteresis and temperature drift. In addition, it is not necessary to detect the accurate rotating angles of the respective auxiliary gears 22 and 23 because the first encoder 2 may detect the number of absolute half-rotations of the main shaft 10. Here, in the embodiment, the number of half-rotations of the main shaft 10 (main gear 21) is calculated based on the combination of the rotating angle of the first auxiliary gear 22 of the first encoder 2 and the rotating angle of the second auxiliary gear 23. As described above, ½ of the number of teeth 2a of the main gear 21, the number of teeth b of the first auxiliary gear 22, and the number of teeth c of the second auxiliary gear 23 are coprime to each other. In this case, a combination of the rotating angle of the first auxiliary gear 22 and the rotating angle of the second auxiliary gear 23, which is acquired whenever the main gear 21 performs half-rotation, is b×c.

Hereinafter, the first data will be described in detail using a case, in which the number of teeth of the main gear 21 is 6, the number of teeth of the first auxiliary gear 22 is 4, and the number of teeth of the second auxiliary gear 23 is 5, as an example.

The number of teeth of the first auxiliary gear 22 is 4. Therefore, if the first auxiliary gear 22 corresponding to one tooth is rotated by the main gear 21, the first auxiliary gear 22 is rotated by 90°. Here, actually, a detection signal, which is at a signal level according to the rotating angle of the first auxiliary gear 22, is output from the first magnetic angle sensor 26. For convenience of explanation, it is assumed that “0” is output in a case in which the rotating angle of the first auxiliary gear 22, which is detected by the first magnetic angle sensor 26, is included in a range of ±45° based on the initial position, “1” is output in a case in which the first auxiliary gear 22 corresponding to one tooth is rotated (in a case of the rotating angle in a range of 45° or larger and 135° or smaller from the initial position), “2” is output in a case in which the first auxiliary gear 22 corresponding to two teeth is rotated (in a case of the rotating angle in a range of 135° or larger and 225° or smaller from the initial position), and “3” is output in a case in which the first auxiliary gear 22 corresponding to three teeth is rotated (in a case of the rotating angle in a range of 225° or larger and 315° or smaller from the initial position). In a case in which the first auxiliary gear 22 corresponding to four teeth is rotated, the first auxiliary gear 22 returns to the initial position, and thus “0” is output.

Similarly, as a signal which is output from the second magnetic angle sensor 27, “0” is output in a case in which the second auxiliary gear 23 is positioned in the initial position (in a case of the rotating angle in a range of ±36° based on the initial position), “1” is output in a case in which the second auxiliary gear 23 corresponding to one tooth is rotated (in a case of the rotating angle in a range of 36° or larger and 108° or smaller from the initial position), “2” is output in a case in which the second auxiliary gear 23 corresponding to two teeth is rotated (in a case of the rotating angle in a range of 108° or larger and 180° or smaller from the initial position), “3” is output in a case in which the second auxiliary gear 23 corresponding to three teeth is rotated (in a case of the rotating angle in a range of 180° or larger and 252° or smaller from the initial position), and “4” is output in a case in which the second auxiliary gear 23 corresponding to four teeth is rotated (in a case of the rotating angle in a range of 252° or larger and 324° or smaller from the initial position). In a case in which the second auxiliary gear 23 corresponding to five teeth is rotated, the second auxiliary gear 23 returns to the initial position, and thus “0” is output.

In the above-described example, in a state in which the main gear 21 is not rotated (is positioned in the initial position), “0” is output from the first magnetic angle sensor 26 and the second magnetic angle sensor 27. In addition, whenever the main gear 21 performs half-rotation, “3”, “2”, “1”, and “0” are output in order from the first magnetic angle sensor 26, and “3”, “1”, “4”, “2”, and “0” are output in order from the second magnetic angle sensor 27. That is, the combination of the number of half-rotations of the main shaft 10, a signal from the first magnetic angle sensor 26, and a signal from the second magnetic angle sensor 27 is as below in Table 1.

TABLE 1

| Number of | | |
|---|---|---|
| half-rotations | | |
| performed by the | Signal from first | Signal from second |
| main shaft | magnetic angle sensor | magnetic angle sensor |
| 0 | 0 | 0 |
| 1 | 3 | 3 |
| 2 | 2 | 1 |
| 3 | 1 | 4 |
| 4 | 0 | 2 |
| 5 | 3 | 0 |
| 6 | 2 | 3 |
| 7 | 1 | 1 |
| 8 | 0 | 4 |
| 9 | 3 | 2 |
| 10 | 2 | 0 |
| 11 | 1 | 3 |
| 12 | 0 | 1 |
| 13 | 3 | 4 |
| 14 | 2 | 2 |
| 15 | 1 | 0 |
| 16 | 0 | 3 |
| 17 | 3 | 1 |
| 18 | 2 | 4 |
| 19 | 1 | 2 |
| 20 | 0 | 0 |

Accordingly, as shown in Table 1, the combination of the detection signals which are output from the first magnetic angle sensor 26 and the second magnetic angle sensor 27, which is acquired whenever the main shaft 10 performs half-rotations, includes 20 patterns (the number of teeth “4” of the first auxiliary gear 22×the number of teeth “5” of the second auxiliary gear 23).

In the embodiment, the storage unit 41 stores the first data as shown in Table 1. In a case in which the detection signals from the first magnetic angle sensor 26 and the second magnetic angle sensor 27 are acquired in step S1, the rotation number calculation section 421 acquires the number of absolute half-rotations of the main shaft 10 based on the first data in step S2. For example, in a case in which the detection signal of the first magnetic angle sensor 26 is “3” and the detection signal of the second magnetic angle sensor 27 is “1”, the number of absolute half-rotations of the main shaft 10 is “17”, and thus it means that the main shaft 10 performs 8.5 rotations. That is, the rotation number calculation section acquires the number of absolute half-rotations as “17” based on the first data as shown in Table 1.

Meanwhile, although an example in which a=3, b=4, and c=5 is shown in Table 1, the number of teeth b and c of the first auxiliary gear 22 and the second auxiliary gear 23 may be increased in a case in which a larger number of half-rotations is acquired, and it is possible to detect the number of absolute half-rotations corresponding to the combination of b×c.

### Process of Calculating Relative Rotating Angle

Meanwhile, the above-described detection signal of the first encoder 2 is influenced by magnetic hysteresis and temperature drift, thereby being inappropriate for highly-accurate angle detection. Therefore, in the position detecting apparatus 1 according to the embodiment, a relative rotating angle for the initial position of the main shaft 10 is calculated by performing the process of calculating the relative rotating angle as described above.

Specifically, the angle calculation section 422 first acquires the detection signals from the first light-reception unit 35 and the second light-reception unit 36 in step S3. Thereafter, the angle calculation section 422 calculates the relative rotating angle based on the detection signals and the second data which is stored in the storage unit 41 in step S4.

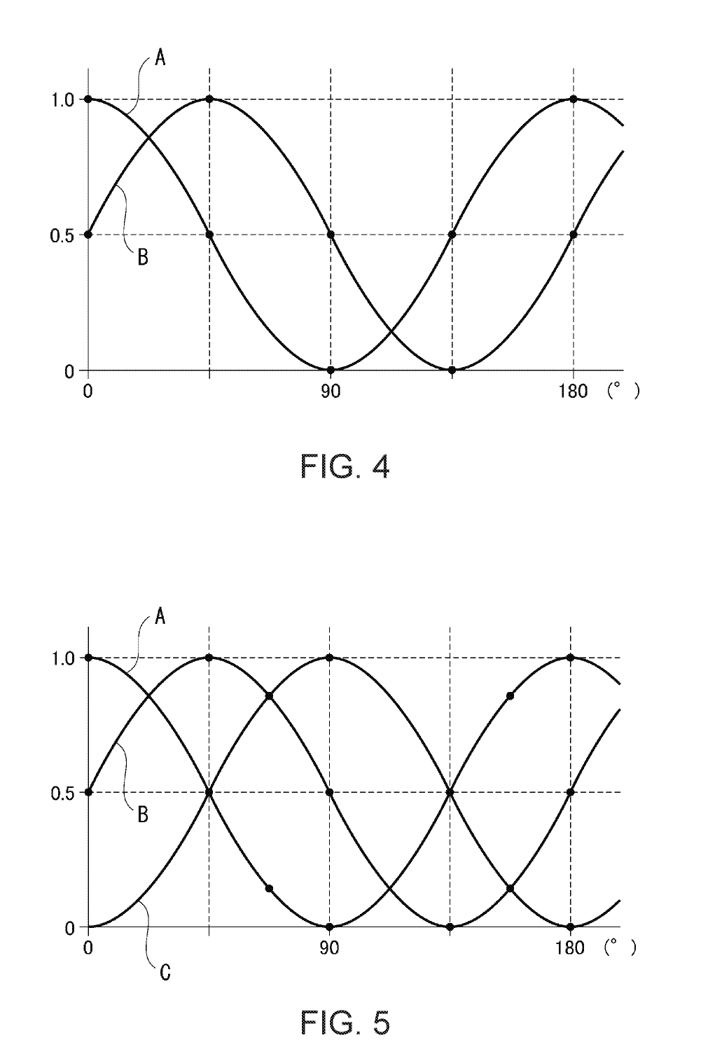

FIG. 4 is a graph illustrating an example of the second data, a horizontal axis indicates the rotating angle of the main shaft 10, and a vertical axis indicates the signal level (relative signal level) of the detection signal. Meanwhile, in FIG. 4, for convenience of explanation, the initial position is set to 0°. However, the invention is not limited thereto, and, for example, a position corresponding to 90° of FIG. 4 may be the initial position.

As illustrated in FIG. 4, in the second data, a relationship between the respective signal levels of the detection signal (first detection signal A) from the first light-reception unit 35, the detection signal (second detection signal B) from the second light-reception unit 36 and the rotating angle of the main shaft 10 is recorded.

That is, as described above, the second polarization plate 32 and the third polarization plate 33 have polarization directions of transmitted light which are deviated by 45° from each other. Therefore, as illustrated in FIG. 4, the first detection signal A and the second detection signal B are output as signal waveforms whose phases are deviated by 45°. Accordingly, in a case in which a relationship between the first detection signal A and the second detection signal B in a range from 0° to 180° is stored as the second data in the storage unit 41, it is possible for the angle calculation section 422 to calculate a relative rotating angle of the main shaft 10 based on the second data and the detection signals A and B from the respective light-reception units 35 and 36.

### Process of Calculating Absolute Rotating Angle

After the process of calculating the number of absolute half-rotations and the process of calculating the relative rotating angle are performed as described above, the absolute rotating angle calculation section 423 performs the process of calculating the absolute rotating angle in step S5.

Specifically, the absolute rotating angle calculation section 423 sets the number of absolute half-rotations, which is calculated by performing the process of calculating the number of absolute half-rotations, to “X”, and sets the relative angle, which is calculated by performing the process of calculating the relative rotating angle, to “Y”, thereby calculating an absolute rotating angle “Z” using following Equation (1).

Z=180×X+Y (1)

### Effects of Embodiment

The position detecting apparatus 1 according to the embodiment includes the first encoder 2 that has the main gear 21 which is provided on the main shaft 10, the first auxiliary gear 22 and the second auxiliary gear 23 which are engaged with the main gear 21, the first magnetic angle sensor 26 which detects the number of rotations of the first auxiliary gear 22, and the magnetic angle sensor 27 which detects the number of rotations of the second auxiliary gear 23. In addition, the position detecting apparatus 1 includes the second encoder 3 that has the first polarization plate 31 which is provided on the main shaft 10, the second polarization plate 32 which faces the first polarization plate 31, the third polarization plate 33 which faces the first polarization plate 31, which is provided in a different position from the second polarization plate 32, and in which a polarization direction is deviated from that of the second polarization plate 32 by 45°, the light source unit 34 which emits light that transmits through the first polarization plate 31, the second polarization plate 32, and the third polarization plate 33, the first light-reception unit 35 which receives light that is transmitted through the first polarization plate 31 and the second polarization plate 32, and the second light-reception unit 36 which receives light that is transmitted through the first polarization plate 31 and the third polarization plate 33.

In the position detecting apparatus 1 as described above, it is possible to detect the number of absolute half-rotations of the main shaft 10 using the first encoder 2, it is possible to detect the relative rotating angle of the main shaft 10 against the initial position using the second encoder 3, and it is possible to easily and highly-accurately calculate the absolute rotating angle of the main shaft 10 using the number of absolute half-rotations and the relative rotating angle.

That is, it is difficult for the first encoder 2 to highly-accurately detect the absolute rotating angle due to the influence of magnetic hysteresis and temperature drift. In contrast, although it is possible for the second encoder 3 to highly-accurately detect the relative rotating angle for the initial position of the main shaft 10, it is difficult for the second encoder 3 to calculate the absolute rotating angle. In contrast, in the embodiment, in a case in which the first encoder 2 acquires the number of rotations of the main shaft and adds the relative rotating angle, which are highly-accurately calculated by the second encoder 3, it is possible to calculate a highly-accurate absolute rotating angle in which the influence of magnetic hysteresis and temperature drift is suppressed. In addition, an optical disk, on which an absolute pattern is formed, or the like is not necessary, and thus the costs of the price are reduced.

In the embodiment, the number of teeth of the main gear 21 is an even number (2a). ½ of the number of teeth of the main gear, the number of teeth (b) of the first auxiliary gear 22, and the number of teeth (c) of the second auxiliary gear 23 have a different number of teeth respectively, that is, a, b, and c are coprime to each other. Therefore, it is possible to combine the number of absolute half-rotations, which is detected by the first encoder 2, with the relative rotating angle which is detected by the second encoder 3, and thus it is possible to calculate a highly-accurate absolute rotating angle.

That is, in a case in which a magnetic-type absolute encoder according to the related art is used, the respective gears are formed such that the number of teeth of the main gear and the number of teeth of each auxiliary gear are coprime to each other. However, the second encoder 3 acquires the relative rotating angle in an angle range from an initial position of 0° to 180°. Therefore, even though the relative rotating angle, which is detected by the second encoder 3, is added to the number of rotations which is detected by the magnetic-type absolute encoder according to the related art, it is difficult to calculate the absolute rotating angle. In contrast, in the embodiment, with the above-described configuration, it is possible to detect the number of rotations of the main shaft 10 in a unit of half-rotation by the first encoder 2, and it is possible to easily and highly-accurately calculate the absolute rotating angle using Equation (1).

### Modification Example

Meanwhile, the invention is not limited to the above-described respective embodiments, and configurations, acquired through modifications, improvements, and appropriate combinations of the respective embodiments in a range in which it is possible to accomplish the object of the invention, are included in the invention.

In the embodiment, a configuration in which the second encoder 3 includes two polarization plates (the second polarization plate 32 and the third polarization plate 33) as the counter polarization plate according to the invention is described as an example. However, the invention is not limited thereto.

For example, three or more polarization plates may be provided as the counter polarization plates. For example, in a case in which three counter polarization plates (a second polarization plate, a third polarization plate, and a fourth polarization plate) are used, the polarization direction of the third polarization plate is deviated from the second polarization plate by 45°, and the polarization direction of the fourth polarization plate is deviated from the third polarization plate by 45° (deviated from the second polarization plate by 90° (tilted)).

Furthermore, light which is transmitted through the first polarization plate and the second polarization plate is received by the first light-reception unit, light which is transmitted through the first polarization plate and the third polarization plate is received by the second light-reception unit, and light which is transmitted through the first polarization plate and the fourth polarization plate is received by a third light-reception unit.

In this case, the angle calculation section 422 calculates the relative rotating angle using the second data as illustrated in FIG. 5. FIG. 5 illustrates an example of the second data corresponding to the modification example, that is, illustrates waveforms of the detection signals which are output from the respective light-reception units. As illustrated in FIG. 5, the relative rotating angle becomes a different angle according to the combination pattern of the signals from the respective light-reception units, and thus it is possible to highly-accurately calculate the relative rotating angle like the second data illustrated in FIG. 4. In addition, with the configuration, the relative rotating angle is acquired based on three detection signals, with the result that, even in a case in which noise or the like is superimposed on the detection signals, it is possible to suppress the influence of the noise compared to the case of two detection signals, and thus it is possible to calculate further highly-accurate relative rotating angle. Accordingly, it is possible to further highly-accurately calculate the absolute rotating angle by the position detecting apparatus.

In the embodiment, the first encoder 2 may have a configuration in which a radial direction magnet and a magnetic angle sensor for the main gear 21, which detect the rotation of the main gear 21, are further provided.

In the embodiment, although a configuration, in which the first encoder 2 is provided with two auxiliary gears 22 and 23, is described as an example, a configuration in which three or more auxiliary gears are provided may be provided. In this case, it is possible to increase a countable number of half-rotations of the main shaft 10.

In addition, although a configuration in which both the first auxiliary gear 22 and the second auxiliary gear 23 are engaged with the main gear 21 is described as an example, the invention is not limited thereto. For example, the respective auxiliary gears 22 and 23 may be connected to the main gear 21 through another gear or another auxiliary gear.

### Second Embodiment

Hereinafter, an embodiment of the invention will be described.

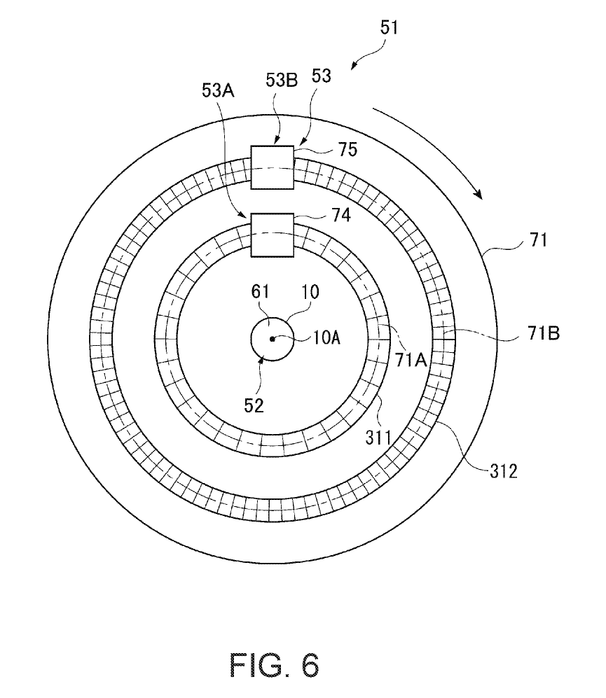

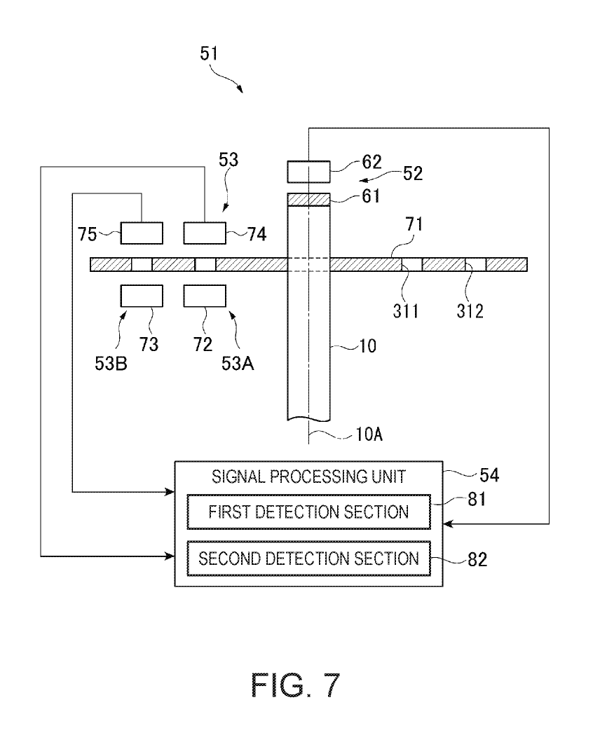

FIG. 6 is a plan view illustrating a schematic configuration of a position detecting apparatus 51 according to the embodiment of the invention, and FIG. 7 is a sectional diagram illustrating the schematic configuration of the position detecting apparatus 51 according to the embodiment.

In FIG. 6, the position detecting apparatus 51 is an absolute rotary encoder which detects an absolute rotating angle within one rotation of the main shaft 10. The position detecting apparatus 51 is attached to a rotation mechanism in an industrial machine (for example, SCARA robot) or the like, and detects a position of the rotation mechanism. For example, in a case in which a position of a drive arm of the industrial machine is detected, the drive shaft of the drive arm is assumed as the main shaft 10, and the position detecting apparatus 51 according to the embodiment is attached to the drive shaft. In this case, in a case in which an absolute rotating angle of the drive shaft is detected, it is possible to detect a position (for example, an arm angle or the like) of the drive arm.

Furthermore, the position detecting apparatus 51 includes a magnetic angle sensor 52, an optical-type encoder 53, and a signal processing unit 54 (refer to FIG. 7) as illustrated in FIGS. 6 and 7.

### Configuration of Magnetic Angle Sensor

The magnetic angle sensor 52 is an angle detection sensor according to the invention, and detects the rotating angle of the main shaft 10. The magnetic angle sensor 52 includes a magnet 61 which is provided at the end of the main shaft 10, and an angle detection unit 62 (refer to FIG. 7) which faces the magnet 61 as illustrated in FIGS. 6 and 7.

The magnet 61 is a radial direction magnet which is provided on a surface which is perpendicular to the shaft center 10A of the main shaft 10, and which has magnetic poles that are different from each other on one side and the other side along the radial direction of the main shaft 10.

The angle detection unit 62 detects the rotating angle of the main shaft 10 from a magnetic moment which is changed by the magnet 61 that is rotated together with the main shaft 10, and outputs a detection signal (first detection signal). The angle detection unit 62 can detect a rotating angle (absolute rotating angle) from a prescribed initial position of the main shaft 10.

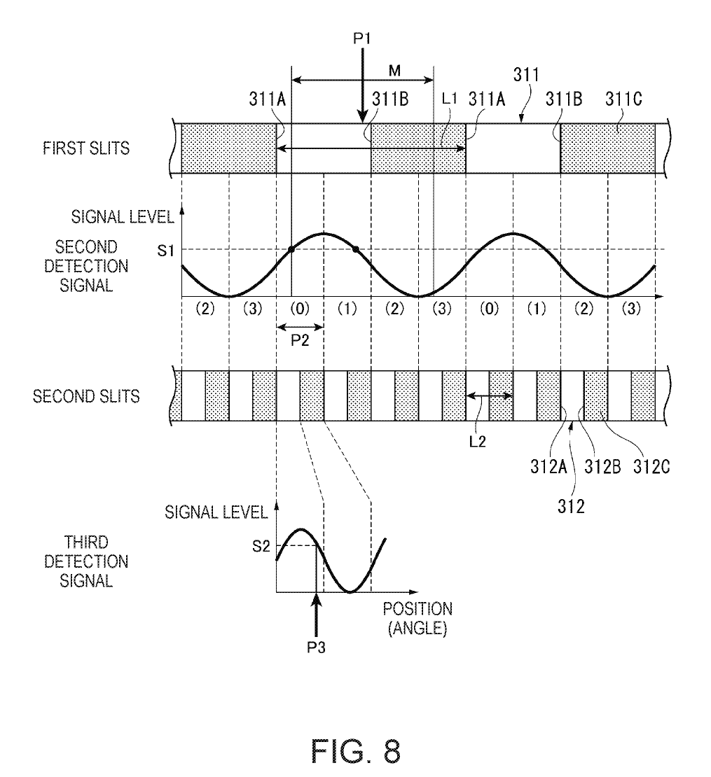

Meanwhile, it is possible to simplify the configuration and to reduce the costs in the magnetic angle sensor 52. However, the magnetic angle sensor 52 is influenced by magnetic hysteresis and temperature drift, and thus it is difficult to acquire sufficient measurement accuracy. It is possible to measure an error (a prescribed error M (refer to FIG. 8)), which may be generated in a case in which an angle is measured by the magnetic angle sensor 52, in advance in, for example, inspection at production. Meanwhile, the prescribed error M means a fact that a true value (actual position) exists within a range of the prescribed error M based on the position which is detected by the magnetic angle sensor 52.

### Configuration of Optical Encoder

Subsequently, the optical-type encoder 53 will be described.

The optical-type encoder 53 includes a rotation body 71, a first light source 72 (refer to FIG. 7), a second light source 73 (refer to FIG. 7), a first light-reception unit 74 (corresponding to a first detection unit according to the invention), and a second light-reception unit 75 (corresponding to a second detection unit according to the invention).

The rotation body 71 is, for example, a discoid planar substrate which is perpendicular to the shaft center 10A of the main shaft 10, is fixed to the main shaft 10, and is capable of performing rotation together with the main shaft 10. The rotation body 71 includes a plurality of first slits 311 which are arranged along a first virtual circle 71A (refer to FIG. 6) based on the shaft center 10A of the main shaft 10, and a plurality of second slits 312 which are arranged along a second virtual circle 71B (refer to FIG. 6) that has the same axis as the first virtual circle 71A and has a larger diameter compared to the first virtual circle 71A.

Here, a first encoder 53A includes the first slits 311, the first light source 72, and the first light-reception unit 74, and a second encoder 53B includes the second slits 312, the second light source 73, and the second light-reception unit 75. Furthermore, in the position detecting apparatus 51 according to the embodiment, an absolute position within one rotation of the main shaft 10 is detected by the magnetic angle sensor 52 and the first encoder 53A, and the rotating angle of the main shaft 10 is further highly-accurately detected by the second encoder 53B.

### Configuration of First Encoder

As described above, the first encoder 53A includes the first slits 311, the first light source 72, and the first light-reception unit 74.

The first light source 72 is fixed to, for example, a wall (not illustrated in the drawing) of a housing or the like which stores the optical-type encoder 53 in a position which faces the first virtual circle 71A of the rotation body 71.

The first light-reception unit 74 is fixed to, for example, a wall (not illustrated in the drawing) of a housing or the like which stores the optical-type encoder 53 in a surface on a side opposite to the first light source 72 of the rotation body 71 and in a position which faces the first virtual circle 71A of the rotation body 71.

FIG. 8 is a graph illustrating slit interval between the first slits 311 which form the first encoder 53A and slit interval between the second slits 312 which form the second encoder 53B according to the embodiment.

In the optical-type first encoder 53A as described above, light which is emitted from the first light source 72 is incident into the first slits 311, and diffracted light which passes through the first slits 311 is incident into the first light-reception unit 74. Therefore, the detection signal (second detection signal) according to the rotating angle of the rotation body 71 (main shaft 10) is output from the first light-reception unit 74.

Here, a signal waveform of the second detection signal from the first light-reception unit 74 changes the rotation body 71 (main shaft 10) in a sin wave shape, as illustrated in FIG. 8, for the change in the rotating angle. Accordingly, in a case in which the second detection signal and the differential signal thereof are acquired, it is possible to detect the position of the first light-reception unit 74, which is positioned in the rotation body 71, and it is possible to detect the rotating angle of the rotation body 71 (main shaft 10).

Here, in FIG. 8, one end of each of the first slits 311, which form the first encoder 53A, along the first virtual circle 71A is set to a first end 311A, and the other end is set to a second end 311B. In the embodiment, a light and dark pattern, in which the first slits 311 are bright between the first ends 311A of the adjacent first slits 311 (or between the second ends 311B of the adjacent first slits 311) and ribs 311C are dark between the adjacent first slits 311, is formed, and a plurality of light and dark patterns are arranged along the first virtual circle 71A.

Furthermore, in the embodiment, it is preferable that a linear dimension (light and dark width L1) of each of the light and dark patterns is equal to or larger than 4/3 of the prescribed error M of the magnetic angle sensor 52, and the light and dark width L1 is equal to 4/3 times of the prescribed error M. In other words, the magnetic angle sensor 52 has accuracy in which the prescribed error M is included in ¾ of the light and dark width L1 of the light and dark pattern.

### Configuration of Second Encoder

As described above, the second encoder 53B includes the second slits 312, the second light source 73, and the second light-reception unit 75.

The second light source 73 is fixed to, for example, a wall of a housing or the like which stores the optical-type encoder 53 in a position which faces the second virtual circle 71B of the rotation body 71.

The second light-reception unit 75 is fixed to, for example, the wall of the housing or the like which stores the optical-type encoder 53 in a surface on a side opposite to the second light source 73 of the rotation body 71, and in the position which faces the second virtual circle 71B of the rotation body 71.

Meanwhile, it is preferable that the second light source 73 and the second light-reception unit 75 are provided in parallel to the first light source 72 and the first light-reception unit 74 along the radial direction of the main shaft 10.

The optical-type second encoder 53B as described above is capable of detecting the rotating angle of the main shaft 10 using the same measurement principle as the first encoder 53A. In the case in which light which is emitted from the second light source 73 is incident into the second slits 312 and the diffracted light which passes through the second slits 312 is incident into the second light-reception unit 75, the detection signal (third detection signal) in a sin wave shape is output from the second light-reception unit 75 according to the rotating angle of the rotation body 71 (main shaft 10). Accordingly, it is possible to detect the position of the second light-reception unit 75 against the rotation body 71, that is, the rotating angle of the main shaft 10 by acquiring the third detection signal and the differential signal thereof.

Furthermore, the slit interval between the second slits 312 in the second encoder 53B is shorter than the slit interval between the first slits 311.

That is, in a case in which one end of each of the second slits 312 along the second virtual circle 71B is set to a third end 312A and the other end is set to a fourth end 312B, a light and dark pattern, in which a second slit 312 between the third ends 312A of the adjacent second slits 312 (or between the fourth ends 312B of the adjacent second slits 312) is bright and a rib 312C between the adjacent second slits 312 is dark, is formed, and a plurality of light and dark patterns are arranged along the second virtual circle 71B. Furthermore, a light and dark width L2 of the light and dark pattern of the second slits 312 is shorter than the light and dark width L1 of the light and dark pattern of the first slits 311. It is possible to appropriately set the light and dark width L2 according to resolution which is required by the position detecting apparatus 51. For example, in a case in which the resolution of the first encoder 53A is ¼ of the light and dark width L1, the light and dark width L2 of the second slits 312 is set to ¼ of the light and dark width L1 or shorter.

### Configuration of Signal Processing Unit

The respective detection signals from the magnetic angle sensor 52 and the optical-type encoder 53 are input to the signal processing unit 54, and the signal processing unit 54 detects the rotating angle (absolute rotating angle) within one rotation of the main shaft 10 based on the input signals.

The signal processing unit 54 includes a first detection section 81 and a second detection section 82.

The first detection section 81 detects the absolute position of the rotating angle within one rotation of the main shaft 10 based on the detection signals (the first detection signal and the second detection signal) which are output from the magnetic angle sensor 52 and the first encoder 53A of the optical-type encoder 53. That is, the first detection section 81 detects the rotating angle of the main shaft 10 from the initial position.

The second detection section 82 detects a more detailed rotating angle in the absolute position, which is detected by the first detection section 81, based on the third detection signal which is output from the second encoder 53B of the optical-type encoder 53.

The first detection section 81 and the second detection section 82 are formed as hardware by combining a plurality of circuit chips. Meanwhile, the signal processing unit 54 is not limited thereto, and, the signal processing unit 54 may include, for example, a storage unit that stores data and a program, and an operation unit that performs an operation process based on the respective detection signals from the magnetic angle sensor 52 and the optical-type encoder 53. In this case, the operation unit functions as the first detection section 81 and the second detection section 82 in such a way that the operation unit reads and executes the program which is stored in the storage unit.

### Position Detection Method Using Position Detecting Apparatus (Method of Detecting Rotating Angle of Main Shaft)

In the position detecting apparatus 51, in a case in which the main shaft 10 is rotated, the respective detection signals are output to the signal processing unit 54 from the magnetic angle sensor 52 and the first light-reception unit 74 and the second light-reception unit 75 of the optical-type encoder 53.

In a case in which the detection signals from the magnetic angle sensor 52 and the optical-type encoder 53 are input to the signal processing unit 54, the first detection section 81 detects the rotating angle (absolute position) within one rotation of the main shaft 10 based on the first detection signal from the magnetic angle sensor 52. Furthermore, the first detection section 81 specifies accurate information of the absolute position based on the second detection signal from the first light-reception unit 74 of the first encoder 53A.

Specifically, as illustrated in FIG. 8, the first detection section 81 detects the rotating angle of the main shaft 10 (temporary absolute position P1) based on the first detection signal from the magnetic angle sensor 52. There is a possibility that the temporary absolute position P1 includes a measurement error within the range of the prescribed error M, as illustrated in FIG. 8. Therefore, the first detection section 81 specifies a position corresponding to the second detection signal from the first encoder 53A as an absolute position P2 within the range of the prescribed error M around the temporary absolute position P1 based on the first detection signal.

However, in the embodiment, the light and dark width L1 of the light and dark pattern of the first slits 311 has a dimension which is equal to or larger than the prescribed error M of the magnetic angle sensor 52 by 4/3, thereby being a relatively large slit width. In this case, the cycle of the second detection signal, which is output from the first light-reception unit 74, becomes long to correspond to the light and dark width L1, and thus high resolution is not acquired. For example, in a case in which the resolution of the first encoder 53A is ¼ of the light and dark width L1, any one of positions (0) to (3) illustrated in FIG. 8 is detected as the absolute position P2. More specifically, in a case in which the signal level of the second detection signal is S1 (refer to FIG. 8) and the differential signal of the second detection signal is a positive value, the first detection section 81 specifies the position (0) illustrated in FIG. 8 as the absolute position P2.

Thereafter, the second detection section 82 detects the rotating angle of the main shaft 10 with high resolution based on the third detection signal which is output from the second light-reception unit 75 of the second encoder 53B.

That is, the light and dark width L2 of the light and dark pattern of the second slits 312 is shorter than the light and dark width L1 of the first slits 311, and thus the resolution of the second encoder 53B is high compared to the first encoder 53A. Therefore, in a case in which the absolute position P2, which is detected by the first detection section 81, corresponds to low resolution as described above, it is possible to detect a high-resolution position based on the third detection signal from the second encoder 53B. For example, as illustrated in FIG. 8, in a case in which the signal level of the third detection signal is S2 and the differential signal thereof is a negative value, an absolute position P3 is detected.

Furthermore, the position detecting apparatus 51 according to the embodiment outputs an angle ranging from the initial position to the absolute position P3 as the absolute rotating angle of the main shaft 10.

### Measurement Accuracy of Position Detecting Apparatus

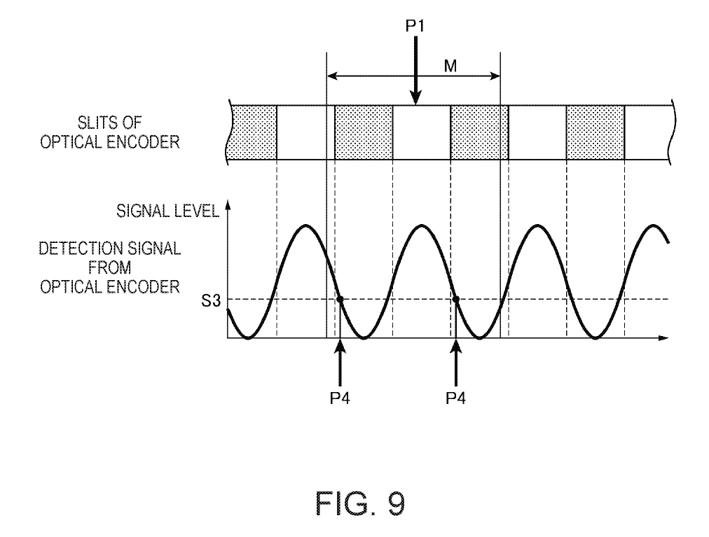

FIG. 9 is a graph illustrating an example of a prescribed error of the magnetic angle sensor and the detection signal of the optical-type encoder in a rotary encoder according to the related art. The example of FIG. 9 illustrates the rotary encoder according to the related art in which the absolute position P1 is detected by the magnetic angle sensor and the highly-accurate measurement is performed by the optical encoder. In the rotary encoder according to the related art, the relationship between the prescribed error M of the magnetic angle sensor and the optical-type encoder is not taken into consideration. Accordingly, there is a case in which the absolute position P1 which is detected by the magnetic angle sensor includes an error within the prescribed error M due to the influence of magnetic hysteresis and temperature drift.

Here, in a case in which the slit interval of the optical-type encoder is smaller than 4/3 of the prescribed error M, there is a case in which a plurality of (two) detection positions P4 corresponding to the signal level “S3” of the detection signal from the optical-type encoder exist, as illustrated in FIG. 9. In this case, it is difficult to determine which one of the positions P4 is the accurate position, and thus the detection accuracy of the rotary encoder is lowered.

In contrast, in the embodiment, as described above, the light and dark width L1 of the first slits 311 is 4/3 of the prescribed error M of the magnetic angle sensor 52. Therefore, even in a case in which the angle, which is measured by the magnetic angle sensor 52, includes the error of the prescribed error M, only one position corresponds to the second detection signal in the prescribed error M, and thus it is possible to specify the accurate absolute position P2.

In addition, the measurement is performed using the second encoder 53B, which includes the second slits 312 whose slit interval is shorter than that of the first slits 311, and thus it is possible to detect a high-resolution absolute position P3.

### Effects of Embodiment

The position detecting apparatus 51 according to the embodiment includes the magnetic angle sensor 52 and the optical-type encoder 53, and the optical-type encoder 53 includes the first encoder 53A and the second encoder 53B. Furthermore, the first encoder 53A includes the plurality of first slits 311 which are provided along the first virtual circle 71A around the rotation center of the rotation body 71, the first light source 72 which irradiates the first slits 311 with light, and the first light-reception unit 74 which receives diffracted light that passes through the first slits 311. Furthermore, in the embodiment, the light and dark width L1 of the first slits 311 is equal to or longer than 4/3 of the prescribed error M of the magnetic angle sensor 52.

In the position detecting apparatus 51, even in a case in which the absolute position P1 (temporary absolute position P1) based on the first detection signal which is output from the magnetic angle sensor 52 is a position which includes the measurement error within a range of the prescribed error M due to the influence of magnetic hysteresis and temperature drift, it is possible to detect the accurate absolute position P2 based on the second detection signal from the first encoder 53A. In this case, the light and dark width L1 of the first slits 311 is equal to or longer than 4/3 of the prescribed error M, and thus the absolute position P2 corresponding to the second detection signal within the range of the prescribed error M is specified to one. Accordingly, a plurality of positions corresponding to the second detection signal, as illustrated in FIG. 9 do not exist, and thus it is possible to easily and highly-accurately detect the absolute position P2 (that is, the rotating angle from the initial position of the main shaft 10).

In the embodiment, the second encoder 53B of the optical-type encoder 53 includes the second slits 312 whose slit interval is shorter than that of the first slits 311.

In a case in which the above-described first encoder 53A is used, it is possible to detect the accurate absolute position P2 when the absolute position is detected by the magnetic angle sensor 52 even in a case in which an error occurs due to the influence of magnetic hysteresis and temperature drift. In contrast, the light and dark width L1 of the light and dark pattern of the first encoder 53A is larger than the prescribed error M, and thus resolution is lowered. In contrast, in the embodiment, position detection is also performed using the above-described second encoder 53B. Therefore, it is possible to perform further higher resolution position detection in the absolute position P2, which is detected by the magnetic angle sensor 52 and the first encoder 53A, and it is possible to detect the highly definition absolute position P3.

In the embodiment, the first slits 311 which form the first encoder 53A are arranged along the first virtual circle 71A around the shaft center 10A of the main shaft 10, and the second slits 312 which form the second encoder 53B are arranged along the second virtual circle 71B which has the same axis as the first virtual circle 71A and has a larger diameter compared to the first virtual circle 71A. With the configuration, it is possible to arrange the plurality of second slits 312 whose slit interval is short along the second virtual circle 71B which has a long circumference, and it is possible to detect the rotating angle of the main shaft 10 with higher resolution.

### Modification Example

Meanwhile, the invention is not limited to the above-described respective embodiments. Configurations, which are acquired through modifications, improvements, and appropriate combinations of the respective embodiments in a range in which it is possible to accomplish the object of the invention, are included in the invention.

In the embodiment, a configuration in which the first slits 311 are arranged along the first virtual circle 71A, and the second slits 312 are arranged along the second virtual circle 71B is described as an example. However, the invention is not limited thereto. For example, a configuration in which the first slits 311 are arranged along the second virtual circle 71B and the second slits 312 are arranged along the first virtual circle 71A may be applied.

In the embodiment, an example in which the light and dark width L2 of the second slits 312 is set to ¼ of the resolution of the first encoder 53A is shown. However, the invention is not limited thereto. For example, the second encoder 53B may be formed such that the light and dark width L2 of the second slits 312 is equal to or lower than ¾ of ¼ of the resolution of the first encoder 53A.

In addition, although a configuration in which the first encoder 53A and the second encoder 53B are provided as the optical-type encoder 53 is described as an example, a configuration in which a third encoder that is capable of detecting the rotating angle with resolution higher than that of the second encoder 53B is further provided may be applied.

In this case, for example, the light and dark width of the slits which form the third encoder may be ¼ of the resolution of the second encoder 53B.

Although the magnetic angle sensor 52 is described as an example of the angle detection sensor according to the invention, the invention is not limited thereto. In a case of a sensor which is capable of detecting the absolute rotating angle of the main shaft 10, a sensor which has any configuration may be used as the angle detection sensor. For example, a potentiometer or the like may be used.

In addition, a detailed structure in a case in which the invention is realized may be configured by appropriately combining the respective embodiments and the modification example in a range in which it is possible to accomplish the object of the invention, and may be appropriately changed to another structure or the lie.

The entire disclosures of Japanese Patent Application Nos. 2015-241616, filed Dec. 10, 2015 and 2015-241617, filed Dec. 10, 2015 are expressly incorporated by reference herein.

What is claimed is:

1. A position detecting apparatus comprising:
a main gear that is provided on a main shaft which is capable of rotating around a shaft center, and that is rotated together with the main shaft;
two or more auxiliary gears that are connected to the main gear, configured to have the numbers of teeth which are different from the number of teeth of the main gear, and configured to have the numbers of teeth which are different from each other;
magnetic angle sensors that are respectively provided on the two or more auxiliary gears, and are configured to detect rotating angles of the respective auxiliary gears;
a polarization plate that is provided on the main shaft, and is rotated together with the main shaft;
two or more counter polarization plates that are provided in different positions within an area which faces the polarization plate, and are configured to have polarization directions which are deviated from each other by an interval of 45°;
a light source unit that irradiates the polarization plate and the counter polarization plates with light; and
a light detection unit that detects light which is irradiated from the light source unit and passes through the polarization plate and the counter polarization plates.

2. The position detecting apparatus according to claim 1,
wherein the number of teeth of the main gear is an even number, and
wherein ½ of the number of teeth of the main gear and the number of teeth of each of the two or more auxiliary gears are coprime to each other.
